(19) United States
(12) Patent Application Publication
(10) Pub. No.: US 2024/0131586 A1
(43) Pub. Date: Apr. 25, 2024

(54) CRASHWORTHY ALLOY

(71) Applicant: Divergent Technologies, Inc., Los Angeles, CA (US)

(72) Inventors: Mu LI, San Pedro, CA (US); Keith Mathew MERTAN, Long Beach, CA (US); Chan Cheong PUN, Costa Mesa, CA (US); Michael Thomas KENWORTHY, Rancho Palos Verdes, CA (US)

(21) Appl. No.: 18/488,780

(22) Filed: Oct. 16, 2023

Related U.S. Application Data
(60) Provisional application No. 63/417,938, filed on Oct. 20, 2022.
(60) Provisional application No. 63/425,550, filed on Nov. 15, 2022.

(51) Int. Cl. B22F 10/28; C22C 21/08

(52) U.S. Cl. CPC B22F 10/28; C22C 21/08; B22F 2301/052; B33Y 10/00

(57) ABSTRACT

Alloyed metals, and techniques for creating parts from alloyed metals, are disclosed. An apparatus in accordance with an aspect of the present disclosure comprises an alloy. An additive manufacturing alloy in accordance with the present disclosure may comprise magnesium (Mg) that is between 2.0 and 5.3% by weight, manganese (Mn) that is between 0.01 and 4.0% by weight, silicon (Si) that is between 0.1 and 1.5% by weight, zirconium (Zr) that is between 0.01 and 2.0% by weight, and aluminum (Al). In some cases, the alloy such as described in the previous sentence might not include Mg.

### CROSS-REFERENCE TO RELATED APPLICATIONS

This application claims the benefit of, and right to priority to, U.S. Provisional Application No. 63/417,938 filed on Oct. 20, 2022 and U.S. Provisional Application No. 63/425,550 filed on Nov. 15, 2022, both entitled “Crashworthy Alloy”, the entireties of which are incorporated by reference as if fully set forth herein.

### BACKGROUND

### Field

The present disclosure relates generally to alloyed materials, and more specifically to 3-D printable alloys.

### Background

The present disclosure relates generally to alloyed materials, and more specifically to 3-D printable alloys.

Three-dimensional (3-D) printing, also referred to as additive manufacturing (AM), presents new opportunities to more efficiently build structures such as automobiles, aircraft, boats, motorcycles, busses, trains, and the like. Applying AM processes to industries that produce these products has proven to produce structurally efficient transport structures. For example, an automobile produced using 3-D printed components can be made stronger, lighter, and consequently, more fuel efficient. Moreover, AM enables manufacturers to 3-D print parts that are much more complex and that are equipped with more advanced features and capabilities than parts made via traditional casting, forging, and machining techniques. Despite these recent advances, a number of obstacles remain with respect to the practical implementation of AM techniques. For example, many existing alloys can be cast or molded to produce structures relatively free of defects, but when 3-D printed these alloys exhibit cracking and/or other defects. When components of a specified strength and/or ductility are desired in certain applications, manufacturers may be relegated to manufacturing the component using traditional casting, forging, and machining techniques because 3-D printing the components using existing alloys would result in components that are too weak or brittle.

### SUMMARY

Several aspects and features of 3-D printable metal alloys will be described more fully hereinafter with reference to 3-D printing techniques.

An additive manufacturing alloy in accordance with an aspect of the present disclosure may comprise magnesium (Mg) that is between 2.5 and 5.3% by weight, manganese (Mn) that is between 0.01 and 4.0% by weight, silicon (Si) that is between 0.1 and 1.5% by weight zirconium (Zr) that is between 0.01 and 2.0% by weight, and aluminum (Al).

Such an additive manufacturing alloy may further optionally include at least one of hafnium (Hf), lithium (Li), titanium (Ti), or yttrium (Y), wherein Hf is between 0.01 and 0.8% by weight, Li is between 0.01 and 0.5% by weight, Ti is between 0.01 and 2.0% by weight, and Y is between 0.01 and 1.0% by weight.

Such an additive manufacturing alloy may further optionally include at least one of: nickel (Ni), vanadium (V), zinc (Zn), iron (Fe), copper (Cu), chromium (Cr), or cobalt (Co), wherein Ni is between 0.01 and 4.0% by weight, V is between 0.01 and 2.0% by weight, Zn is between 0.01 and 3.0% by weight, Fe is between 0.01 and 2.5% by weight, Cu is between 0.01 and 2.0% by weight, Cr is between 0.01 and 4.0% by weight, and Co is between 0.01 and 4.0% by weight.

Such an additive manufacturing alloy may have an elongation of an as-printed alloy of at least 15%, at least 17%, or at least 18%.

Such an additive manufacturing alloy may have an ultimate tensile strength of an as-printed alloy of at least 400 megapascals, at least 425 megapascals, at least 440 megapascals, or at least 445 megapascals.

An additive manufacturing alloy in accordance with an aspect of the present disclosure may comprise magnesium (Mg) in a range from 2.0 to 5.3% by weight, manganese (Mn) in a range from 0.7 to 2.9% by weight, silicon (Si) in a range from 0.1 to 0.8% by weight, and zirconium (Zr) in a range from 0.01 to 1.0% by weight.

Such an additive manufacturing alloy may further optionally include at least one of hafnium (Hf), lithium (Li), titanium (Ti), or yttrium (Y), wherein Hf is between 0.01 and 0.8% by weight, Li is between 0.01 and 0.5% by weight, Ti is between 0.01 and 1.0% by weight, and Y is between 0.01 and 1.0% by weight.

Such an additive manufacturing alloy may further optionally include at least one of nickel (Ni), vanadium (V), zinc (Zn), iron (Fe), copper (Cu), chromium (Cr), or cobalt (Co), wherein Ni is between 0.01 and 4.0% by weight, V is between 0.01 and 2.0% by weight, Zn is between 0.01 and 3.0% by weight, Fe is between 0.01 and 2.5% by weight, Cu is between 0.01 and 2.0% by weight, Cr is between 0.01 and 4.0% by weight, and Co is between 0.01 and 4.0% by weight.

Such an additive manufacturing alloy may have an elongation of an as-printed alloy of at least 15%, at least 17%, or at least 18%.

Such an additive manufacturing alloy may have an ultimate tensile strength of an as-printed alloy of at least 400 megapascals, at least 425 megapascals, at least 440 megapascals, or at least 445 megapascals.

An additive manufacturing alloy in accordance with an aspect of the present disclosure may comprise manganese (Mn) in a range from 0.7 to 2.9% by weight, silicon (Si) in a range from 0.1 to 0.8% by weight, zirconium (Zr) in a range from 0.01 to 1.0% by weight, and aluminum (Al).

Such an additive manufacturing alloy may further optionally include at least one of hafnium (Hf), lithium (Li), titanium (Ti), or yttrium (Y), wherein Hf is between 0.01 and 0.8% by weight, Li is between 0.01 and 0.5% by weight, Ti is between 0.01 and 2.0% by weight, and Y is between 0.01 and 1.0% by weight.

Such an additive manufacturing alloy may further optionally include at least one of nickel (Ni), vanadium (V), zinc (Zn), iron (Fe), copper (Cu), chromium (Cr), or cobalt (Co), wherein Ni is between 0.01 and 4.0% by weight, V is between 0.01 and 2.0% by weight, Zn is between 0.01 and 3.0% by weight, Fe is between 0.01 and 2.5% by weight, Cu is between 0.01 and 2.0% by weight, Cr is between 0.01 and 4.0% by weight, and Co is between 0.01 and 4.0% by weight.

Such an additive manufacturing alloy may have an elongation of an as-printed alloy of at least 15%, at least 17%, or at least 18%.

Such an additive manufacturing alloy may have an ultimate tensile strength of an as-printed alloy of at least 400 megapascals, at least 425 megapascals, at least 440 megapascals, or at least 445 megapascals.

An additive manufacturing alloy in accordance with an aspect of the present disclosure may comprise manganese (Mn) in a range from 0.01 to 2.9% by weight, silicon (Si) in a range from 0.01 to 3.9% by weight, zirconium (Zr) in a range from 0.01 to 2.8% by weight, and aluminum (Al).

Such an additive manufacturing alloy may further optionally include at least one of hafnium (Hf), lithium (Li), titanium (Ti), or yttrium (Y), wherein Hf is between 0.01 and 0.8% by weight, Li is between 0.01 and 0.5% by weight, Ti is between 0.01 and 2.0% by weight, and Y is between 0.01 and 1.0% by weight.

Such an additive manufacturing alloy may further optionally include at least one of nickel (Ni), vanadium (V), zinc (Zn), iron (Fe), copper (Cu), chromium (Cr), or cobalt (Co), wherein Ni is between 0.01 and 4.0% by weight, V is between 0.01 and 2.0% by weight, Zn is between 0.01 and 3.0% by weight, Fe is between 0.01 and 2.5% by weight, Cu is between 0.01 and 4.0% by weight, Cr is between 0.01 and 4.0% by weight, and Co is between 0.01 and 4.0% by weight.

It will be understood that other aspects of printable alloys will become readily apparent to those skilled in the art from the following detailed description, wherein it is shown and described only several embodiments by way of illustration. As will be appreciated by those skilled in the art, the principles of the disclosure can be realized with other embodiments without departing from the invention. Accordingly, the drawings and detailed description are to be regarded as illustrative in nature and not as restrictive.

### BRIEF DESCRIPTION OF THE DRAWINGS

Various aspects of the present disclosure will now be presented in the detailed description by way of example, and not by way of limitation, in the accompanying drawings, wherein:

FIGS. 1A-1D illustrate respective side views of a 3-D printer system in accordance with an aspect of the present disclosure;

FIG. 1E illustrates a functional block diagram of a 3-D printer system in accordance with an aspect of the present disclosure;

FIGS. 2A-2C illustrate alloy structures in accordance with an aspect of the present disclosure;

FIG. 3 illustrates a unit cell of a structure in accordance with an aspect of the present disclosure;

FIG. 4 shows a flow diagram illustrating an exemplary method for additively manufacturing a component in accordance with an aspect of the present disclosure;

FIG. 5 illustrates an assembly in accordance with an aspect of the present disclosure;

FIG. 6 illustrates a cross-sectional view of an assembly in accordance with an aspect of the present disclosure; and

FIG. 7 illustrates a joint feature of an assembly in accordance with an aspect of the present disclosure.

### DETAILED DESCRIPTION

The detailed description set forth below in connection with the drawings is intended to provide a description of exemplary embodiments of 3-D printable alloys, and it is not intended to represent the only embodiments in which the invention may be practiced. The term “exemplary” used throughout this disclosure means “serving as an example, instance, or illustration,” and should not necessarily be construed as preferred or advantageous. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

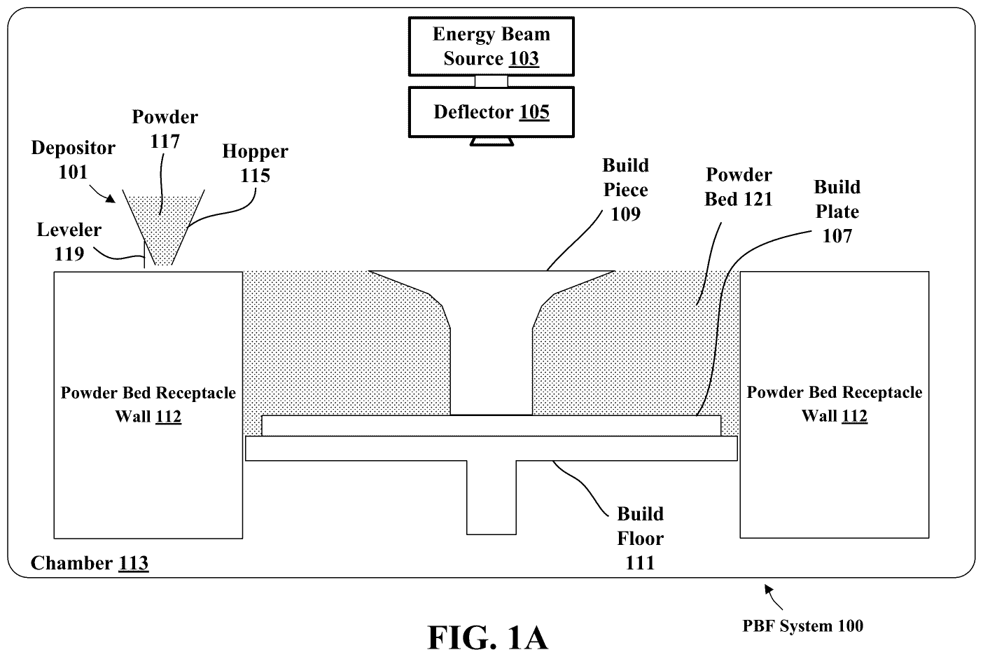

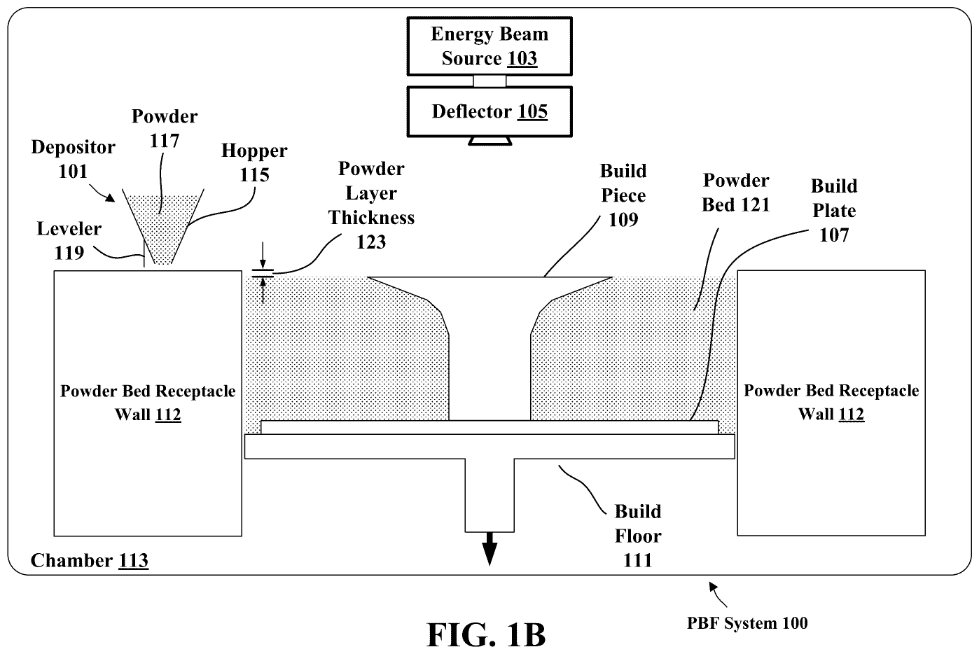

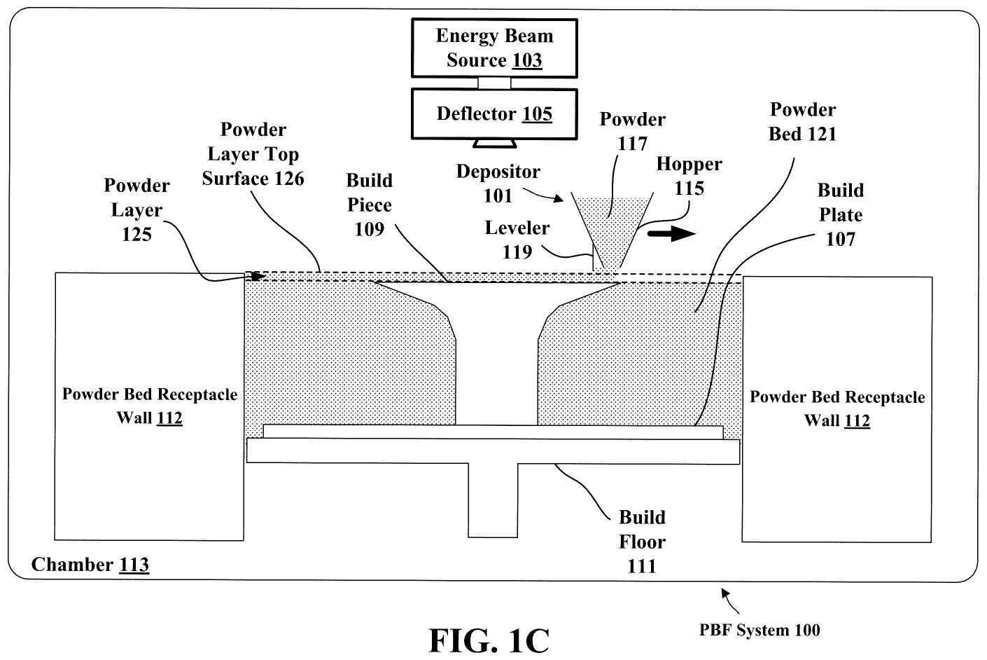

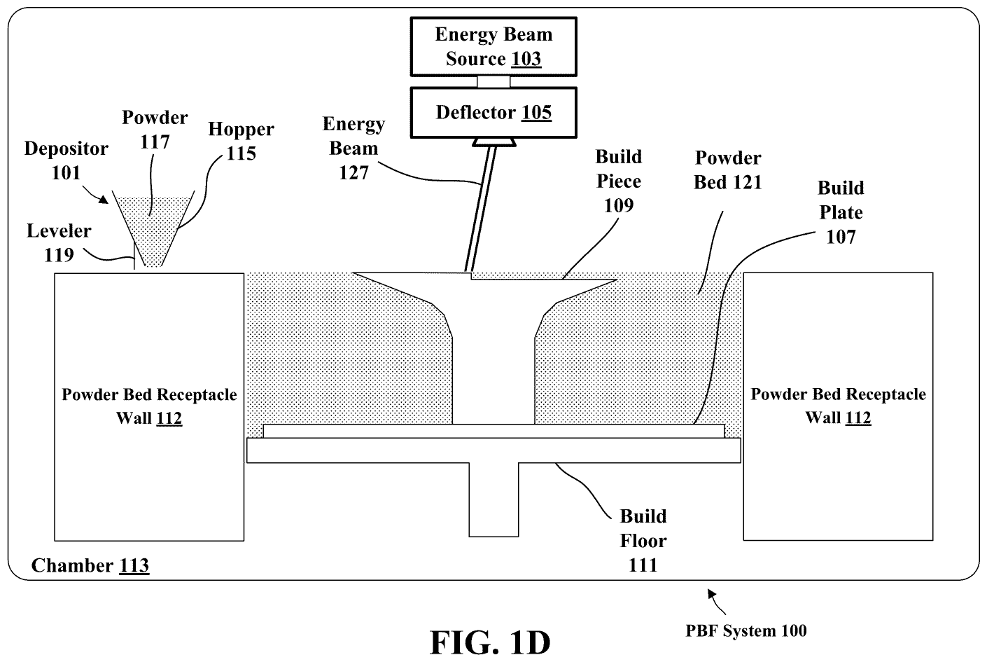

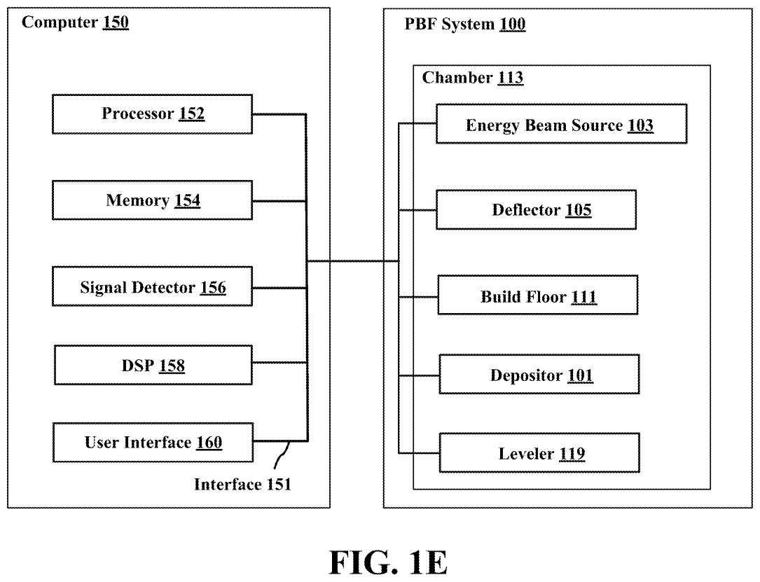

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation, and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 175 layers, to form the current state of build piece 109, e.g., formed of 175 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 with a powder layer top surface 126 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 174 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and one or more user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random-access memory (RAM), may provide instructions and/or data to the processor 152. A portion of the memory 154 may also include non-volatile random-access memory (NVRAM). The processor 152 typically performs logical and arithmetic operations based on program instructions stored within the memory 154. The instructions in the memory 154 may be executable (by the processor 152, for example) to implement the methods described herein.

The processor 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117 remaining in depositor 101, leveler 119 position, and other signals. DSP 158 may be used in processing signals received by the computer 150. The DSP 158 may be configured to generate instructions and/or packets of instructions for transmission to PBF system 100.

The user interface 160 may comprise a keypad, a pointing device, and/or a display. The user interface 160 may include any element or component that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor 152 may be used to implement not only the functionality described above with respect to the processor 152, but also to implement the functionality described above with respect to the signal detector 156, the DSP 158, and/or the user interface 160. Further, each of the components illustrated in FIG. 1E may be implemented using a plurality of separate elements.

Alloy Compositions

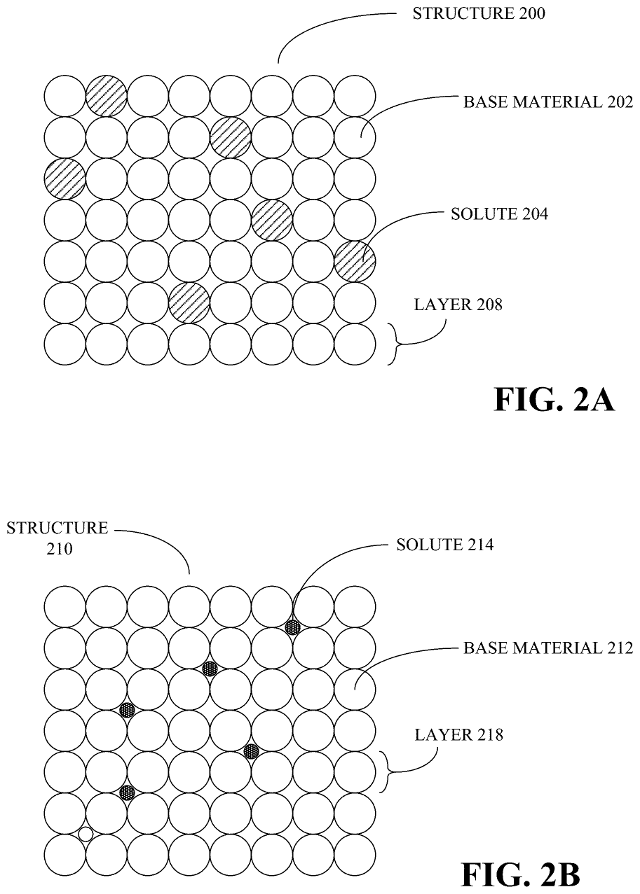

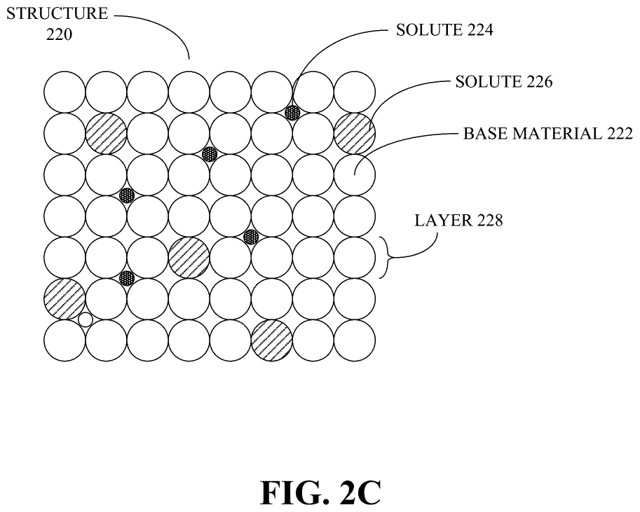

FIGS. 2A and 2B illustrate alloy structures in accordance with an aspect of the present disclosure.

FIG. 2A illustrates an alloy structure 200 with base material atoms and solute 204 atoms included in alloy structure 200. In an aspect of the present disclosure, alloy structure 200 may have an underlying structure of the base material, which may be, for example, a crystalline-type or periodic structure, such as a cubic structure, i.e., where an atom of the base material is located at each corner of a cube, a face-centered cubic structure, i.e., where an atom of the base material is located at the corners and in at least one face of a cube, etc. For example, as a base material, aluminum (Al) metal arranges in a face-centered cubic (fcc) structure, titanium arranges in a body-centered cubic (bec) structure or a hexagonal close packed (hcp) structure, etc. As shown in FIG. 2A, atoms of base material 202 can be arranged in layers, such as a base material layer 208, which may include one or more atoms of substitutional solute 204.

In FIG. 2A, the base material structure of alloy structure 200 is shown as a cubic structure, however, the principles described with respect to alloy structure 200 may be applied to any base material structural arrangement without departing from the scope of the present disclosure. In FIG. 2A, at some locations within alloy structure 200, base material 202 has been replaced by solute 204. With a replacement approach, an alloy may be referred to as a “substitutional alloy,” because the solute 204 is substituting for the base material 202 within the base material structure of alloy structure 200. In an aspect of the present disclosure, solute 204 may be one or more different atoms and/or compounds that act as substitutional replacements for base material 202. For example, and not by way of limitation, base material 202 may be iron (Fe), and solute 204 may be one or more of nickel (Ni), chromium (Cr), and/or tin (Sn). Substitutional alloys may be formed when the solute 204 is of approximately the same atomic size as base material 202.

In FIG. 2B, an alloy structure 210 includes a base material 212 within a cubic structure like the base material structure shown in FIG. 2A. Like FIG. 2A, the principles described with respect to alloy structure 210 may be applied to any base material structural arrangement without departing from the scope of the present disclosure. Alloy structure 210 also includes a solute 214. Solute 214 is included in alloy structure 210 at locations other than the locations of base material 212, i.e., at interstitial locations within base material structure of alloy structure 210. In such an aspect of the present disclosure, an alloy with such an addition to base material 212 may be referred to as a “interstitial alloy,” because the solute 214 is being made part of the structure at interstitial locations within the base material structure of alloy structure 210. In such an aspect, solute 214 may be one or more different atoms and/or compounds that act as interstitial insertions into the base material structure of alloy structure 210. For example, and not by way of limitation, base material 212 may be aluminum (Al), and solute 214 may be one or more of magnesium (Mg), zirconium (Zr), and/or manganese (Mn). Interstitial alloys may be formed when solute 214 is of a smaller atomic size than base material 212. As shown in FIG. 2B, atoms of base material 212 can be arranged in layers, such as a base material layer 218, which may include one or more atoms of interstitial solute 214 interspersed between the layers.

FIG. 2C illustrates an example of a combination alloy, with an alloy structure 220 that can include a base material 222, an interstitial solute 224, and a substitutional solute 226. As shown in FIG. 2C, atoms of base material 222 can be arranged in layers, such as a base material layer 228, which may include one or more atoms of substitutional solute 226 and interspersed with one or more atoms of interstitial solute 224.

Aspects of the present disclosure can include substitutional alloys, interstitial alloys, and combination alloys with combinations of substitutional/interstitial solutes in a given alloy. Further, a base material (such as base material 202, 212, and 222) may include one or more elements, e.g., the base material may be a plurality of two materials, e.g., copper (Cu) and zinc (Zn), without departing from the scope of the present disclosure. Although the use of “base” in base material may mean that the base material is the majority of the composition of the alloy, such meaning is not necessarily always the case in many aspects of the present disclosure. In various embodiments, base material may indicate an underlying structure of the alloy, since different materials have different atomic arrangements, e.g., fec, bcc, cubic, hcp, etc.

In an aspect of the present disclosure, solutes can be included with a base material to change one or more properties that the base material exhibits. For example, and not by way of limitation, carbon (C) may be added to Fe to increase strength and reduce oxidation. In other words, solutes may be added as impurities to a base material to change the characteristics of the bonds between atoms within a base material structure.

In many materials, and in many alloys, there are several basic characteristics that determine the suitability of that material/alloy for a given application. For example, and not by way of limitation, strength, heat resistance, and ductility are three characteristics that may be of interest in certain applications.

As shown in FIGS. 2A-C, a structure of an alloy, which may include base material(s) and solutes, can be classified in terms of its underlying atomic arrangements (e.g., fec, bcc, hcp, etc.). Alloy structures can be made in a number of ways, but they are primarily fashioned by mixing together a base material with solutes (e.g., substitutional and/or interstitial) in various ratios and/or percentages. This may be done through smelting and/or melting the various components into a homogenous liquid and allowing the liquid to cool into a solid form.

The resultant alloy structure, whether interstitial, substitutional, polycrystalline, amorphous, or various combinations, provides different values for the properties of the alloy than the properties of the base material in a pure form. For example, alloying gold (Au) with silver (Ag) makes the resultant alloy harder, i.e., the resultant alloy of Au and Ag has a higher tensile strength than pure Au. Another reason that a pure base material structure may show reduced strength is that covalent and/or ionic bonding between atoms of the same element is limited. Since alloys contain a mixture of atom sizes, and a variety of valence electrons because some of the atoms in the alloy's structure can have slightly different sizes and/or different localized electrical properties, it is more difficult for layers in the base material arrangement, such as base material layers 208, 218, and 228, to shift with respect to one another, as the arrangement of atoms is no longer uniform and the localized bond strength between neighboring atoms may be increased. This increase in strength of the alloy may be due to the slight difference in size of a substitutional solute, the inclusion of an interstitial solute, and/or other reasons.

Strengthening Mechanisms in Metals

As seen with respect to the descriptions accompanying FIGS. 2A-C, there can be a plurality of ways to increase strength of a base material. The “strength” of a given material can also be described in a plurality of ways. The amount of force required to break a material is often referred to as the “tensile strength” or “ultimate tensile strength” of the material, while the amount of force required to permanently bend or deform a material may be referred to as the “yield strength” of the material. Several mechanisms may be responsible for increasing the tensile strength and/or yield strength of a given material. Such mechanisms in alloys may include, for example, changing the “smoothness” between base material layers in the alloy structure, either by introducing a substitutional solute, an interstitial solute, or a combination of substitutional and interstitial solutes. The introduction of solutes can create areas within an alloy structure that are not uniform, and may be referred to as “dislocations” within the alloy.

Dislocations may introduce different attraction and/or repulsion forces, known as stress fields, within an alloy structure. This creates a localized differential between forces within the alloy structure, known as a “pinning point,” that opposes motion of one or more base material layers of the structure proximate that pinning point.

Increasing the number of dislocations per unit of volume of the alloy structure will normally increase the tensile strength and/or yield strength of an alloy versus its base material structure in pure form. However, above a certain point, which may be different for each base material, an increased density of dislocations will begin to lower the tensile strength and/or yield strength of the alloy. If the localized differential of attractive and/or repulsive forces becomes widespread enough, it can reduce and/or eliminate any contribution of attraction and/or repulsive forces of the base material from the overall strength determination for the alloy, or it can cause the alloy structure to change form to a different underlying arrangement of the atoms in the alloy structure (e.g., from fcc to bcc, etc.).

As such, increasing the dislocation density, to a point, increases the shearing force needed to move one base material layer with respect to another. This is so because additional shearing force would be required to move the dislocations that lie within the layer(s) as well as the force needed to move the base material in those base material layers. This increase in shearing force needed to move the dislocations is exhibited as an increase in tensile strength and/or yield strength in the alloy.

However, increasing the strength of a base material may decrease other properties that the base material exhibits when the base material is in a pure form. For example, and not by way of limitation, increasing the strength may decrease the malleability of that base material. It may be known that stronger materials are harder to bend or dent. The malleability and/or elongation abilities of a material is often referred to as the “ductility” of the material. Changing how strong a material is, i.e., the ability of the material to resist force, often also changes how “workable” the material is, i.e., the ability to absorb force through deformation of the material rather than breakage of the material. Although many of the discussions herein refer to strengthening a material, in an aspect of the present disclosure, the strength of a given alloy can be improved without causing a significant effect on the ductility of the alloy.

Work Hardening

A typical structure of a pure base material may be a regular, nearly defect-free lattice. To harden a material through “work hardening,” dislocations are introduced into the base material through forming or otherwise “working” the material. These dislocations can create localized fluctuations of the stress fields in the material, which slightly rearranges the structure of the base material.

Work hardening of a base material may be achieved by applying mechanical and/or thermal stresses to the base material. For example, a sheet of Cu may be hammered, stretched, or run through pressurized rollers to reduce the material thickness. These mechanical stresses introduce dislocations into the Cu structure (which is face centered cubic). This forming of Cu increases the hardness (strength) and decreases the elasticity (commonly referred to as the “ductility”). Similar hardening can be achieved through thermal cycling, e.g., heating and cooling of the material, such as is done with furnaces and quenching of iron to “temper” the material.

As described above, if “working” a base material continues beyond a certain point, the base material will contain too large a concentration of dislocations which may result in fractures, such as micro-fractures and/or visible fractures. Such fractures may be reversible, e.g., through one or more heating and cooling cycles of the material during and/or after working of the base material. Heating and cooling of the material in such a manner may be referred to as “annealing” the base material.

Work hardening may be performed on a base material without introducing a substitutional and/or interstitial solute to form an alloy. Work hardening may also be performed on alloys that include solutes with a base material.

Solid Solution Strengthening

In an aspect of the present disclosure, a substitutional and/or interstitial solute may be added to a base material, which can result in substitutional and/or interstitial point defects in the alloy structure. The solute atoms can cause lattice distortions in the alloy structure that impede dislocation motion. When dislocation motion is impeded, the strength of the material is increased. This particular mechanism of strengthening a base material may be referred to as “solid solution strengthening.”

In solid solution strengthening, the presence of solute atoms can introduce compressive or tensile stresses to the alloy structure lattice, which may interact with nearby dislocations, causing the solute atoms to act as potential barriers to the movement of layers of the structure with respect to each other. These interactions may increase the tensile strength and/or yield strength of a given alloy.

Solid solution strengthening generally depends on the concentration of the solute atoms present in the alloy structure. Some physical properties of substitutional and/or interstitial solute atoms that may be considered when determining which particular element to include in a given alloy may be the shear modulus of the solute atoms, the physical size of solute atoms, the number of valence electrons (also known as the “valency”) of solute atoms, and the symmetry of the solute stress field, as well as other properties.

Precipitation Hardening

As a molten metal alloy cools, the base material atoms may form molecules and/or bond directly with solute(s) (or other impurities) instead of forming bonds with other base material atoms. The molecules/bonds formed between the base material and solute(s) or impurities will likely create different localized properties than in the pure base material structure and/or pure solute(s) structure. One of these properties may be the melting point of the molecule, which may be different than that of the pure base material and/or pure solute(s).

In an aspect of the present disclosure, the molecules may harden at a higher temperature than the pure base material and/or pure solute(s), which may create dislocations in the alloy structure. These dislocations may create substructures within the alloy structure that may be referred to as a different “phase” of the alloy structure. Because molecules of different sizes within the alloy structure may make it more difficult for base material layers to move with respect to each other within the alloy structure, these molecules may assist in creation of a stronger alloy.

This change in properties of the molecules, which may be referred to as a change in “solid solubility” with respect to temperature, when it affects the strength of the resultant alloy, may be referred to as a “precipitation hardening” mechanism. Because the melting points of the elements included in the alloy may be different, precipitation hardening (also known as “precipitation strengthening”) may be dependent upon temperature.

Precipitation hardening uses these changes in solid solubility with respect to temperature to produce fine particles, e.g., molecules as described above, of an impurity phase, or “second phase,” which impede the movement of dislocations. These particles that compose the second phase precipitates act as pinning points in a similar manner.

The particles may be of a similar size, or coherent size, as the base material. If the sizes of the particles and the base material are similar enough, the alloy structure can remain relatively coherent, e.g., can remain in a bcc or cubic form. However, in localized areas of the alloy structure, bowing and/or depressions may exist in the base material layers. This mechanism may be referred to as “coherency hardening” of the alloy structure, which is similar to solid solution hardening.

Where the particles have a different response to shear stress than the base material, this difference may change the tension and or internal stresses within the alloy structure. This response to shear stress is known as the “shear modulus” and because the particles can withstand a different amount of stress, the overall amount of stress that the alloy structure can withstand can be increased. This mechanism of precipitation hardening may be referred to as “modulus hardening” of the alloy structure.

Other types of precipitation hardening may be chemical strengthening and/or order strengthening, which are changes in the surface energy and/or an ordered structure of the particles within the alloy structure, respectively. Any one or more of these mechanisms may be present as a part of precipitation hardening in an alloy in an aspect of the present disclosure.

Dispersion Strengthening

Similar to precipitation hardening, changes in properties of the molecules, scattering different particles, molecules, and/or solutes within an alloy structure that are of different sizes than the base material may create dislocations within the alloy structure. Although these particles may be larger than those used for precipitation hardening, the mechanism of reducing the ability of base material layers from moving with respect to each other is similar. This mechanism may be referred to as “dispersion strengthening” to differentiate it from precipitation hardening. One type of dispersion strengthening is the introduction of an oxide of a base material in the alloy structure.

Grain Boundary Strengthening

In an aspect of the present disclosure, a unit cell of the alloy structure, e.g., one cube of an fcc, bcc, or cubic structure, etc., may be referred to as a “grain” or “crystallite” within the alloy structure. Solutes may affect the alloy structure by changing the average grain size within the alloy structure. When grains within the alloy structure have different sizes, the interface between adjacent grains, known as the “grain boundary,” acts as a dislocation within the alloy structure. Grain boundaries act as borders for dislocation movement, and any dislocation within a grain affects how stresses build up or are relaxed in adjacent grains.

Such a mechanism may be referred to as “grain boundary strengthening” of a base material in an alloy. In an aspect of the present disclosure, grains within the alloy structure may have different crystallographic orientations, e.g., bcc, fcc, cubic, etc. These differing orientations and sizes create grain boundaries within the alloy structure. When the alloy structure is subjected to external stress, slip motion between base material layers may take place. However, the grain boundaries act as an impediment to slip motion between base material layers because the base material layers do not have uniform, even surfaces where slip motion can occur.

Transformation Strengthening

As described above with respect to precipitation hardening, a base material may cool into different “phases” depending on the rate of cooling, the temperature of cooling, and/or other factors. For example, titanium (Ti) may form two different types of grains, known as a-titanium and β-titanium. α-titanium is formed when the molten titanium metal crystallizes at low temperatures, and forms a hcp lattice structure. 3-titanium forms when the molten titanium crystallizes at higher temperatures, and forms a bcc lattice structure. These different structures within an overall alloy structure create a stronger alloy, because the base material layers' smooth interfaces with each other are interrupted by the change in grain size and lattice structure of the different phases of the base material and/or solute(s). This mechanism for strengthening alloys is known as “transformation strengthening.”

In an aspect of the present disclosure, transformed phases of various base materials and/or solutes may occur as a function of heating and/or cooling the resultant alloy during formation of the alloy, e.g., heating the alloy to a certain temperature, cooling the alloy at a certain rate, heat treatment, etc. In an aspect of the present disclosure, during the 3D printing process of a given alloy, the temperature of the energy beam source 103 (e.g., the amount of energy being delivered by energy beam source 103), the speed that the energy beam travels across the powder bed 121 (e.g., the speed of deflector 105), and/or other factors may be selected to supply a desired temperature profile to the powder bed 121. For example, and not by way of limitation, the heating and/or cooling of a given powder 117 may be selected to approximate a heating and/or cooling profile to create desired phases of the base materials and/or solutes in the resultant alloy, and a different heating and/or cooling of a different powder 117 may be selected to create a different temperature profile to create desired phases in that powder 117's resultant alloy. In an aspect of the present disclosure, the temperature profile(s) delivered by PBF system 100 may also account for any post-printing heat treatments, such that the combined printing/heat treatments may be performed in a more efficient manner.

In iron (Fe) structures, high levels of carbon (C) and manganese (Mn) solutes create two different grains within the alloy structure; ferrite, which is a bcc lattice structure, and martensite, which is a body-centered tetragonal (bct) lattice structure. These differing lattices within a Fe-based alloy structure strengthen the Fe into steel, because adjacent ferrite and martensite lattice structures disrupt the planar continuity of the base material layer interfaces, and the solutes (C and Mn) act as interstitial solutes to further disrupt the base material layer planes. Depending on how the alloy is heat treated, other lattice structures of Fe, e.g., austenite (which has an fcc lattice structure), bainite (which has a slightly different sized bct lattice structure than martensite), cementite (orthorhombic Fe₃C), and/or other compounds, may also be formed.

A form of transformation strengthening, such as the creation of cementite in a Fe-based alloy structure, may also be referred to as “triferrite particle formation” within the alloy structure. Of course, if the base material is titanium, such transformation strengthening may be referred to as “tri-titanium particle formation; if the base material is aluminum (Al), such transformation strengthening may be referred to as “trialuminide particle formation,” etc. There also may be other forms of particles formed, such as a base material with two interstitial solutes or between interstitial and substitutional solutes, which may have a “di-” prefix, e.g., titanium diboride where both titanium and boron are used as solutes, etc., without departing from the scope of the present disclosure. Any number of different compounds, described with chemical prefixes, suffixes, and numerical monikers, comprising, consisting essentially of, and/or consisting base material(s) and/or solute(s) may be created within an alloy without departing from the scope of the present disclosure.

Alloy Compositions

In an aspect of the present disclosure, one or more base materials may be used to create an alloy. For example, and not by way of limitation, aluminum (Al) may be used as the base material; however, Al may be mixed with other materials, such as nickel (Ni), copper (Cu), titanium (Ti), iron (Fe), cobalt (Co), molybdenum (Mo), magnesium (Mg), chromium (Cr), and/or other materials, e.g., high entropy alloy (HEA) materials, etc., can be used by themselves as the base material. Other single base materials may also be substituted for Al without departing from the scope of the present disclosure.

In an aspect of the present disclosure, one or more solutes may also be included in an alloy. For example, and not by way of limitation, magnesium (Mg), boron (B), hafnium (Hf), erbium (Er), yttrium (Y), gallium (Ga), vanadium (V), zirconium (Zr), manganese (Mn), silver (Ag), silicon (Si), zinc (Zn), molybdenum (Mo), tungsten (W), niobium (Nb), tantalum (Ta), scandium (Sc), lanthanum (La), germanium (Ge), tin (Sn), antimony (Sb), rubidium (Ru), titanium (Ti), copper (Cu), iron (Fe), and/or other residual elements or compounds may be included without departing from the scope of the present disclosure.

In an aspect of the present disclosure, solutes may be added to the base material to change the tensile strength of the base material. In an aspect of the present disclosure, solutes may be added to the base material to change the tensile strength of the base material, but the introduction of solutes to the base material may not have a corresponding effect in reducing the ductility of the base material. In an aspect of the present disclosure, solutes may be added to the base material to modify the structure of the base material through one or more of work hardening, solid solution strengthening, precipitation hardening, dispersion strengthening, grain boundary strengthening, and/or transformation strengthening (e.g., promotion of trialuminide particle formation, triferrite particle formation, and/or other transformations) without departing from the scope of the present disclosure.

Aluminum-Based Alloys

In an aspect of the present disclosure, Al may be used as a base material to form an alloy structure of an alloy. Pure fine-grained aluminum can exhibit an fcc lattice structure, have a tensile strength of approximately 70 megapascals (MPa), and have an elongation of approximately 10 percent (%).

In an aspect of the present disclosure, an alloy can include aluminum as the base material and four solutes, e.g., magnesium (Mg), manganese (Mn), silicon (Si), and zirconium (Zr), which may be interstitial or substitutional solutes, or some combination thereof. In such an aspect, the structure of the base material, i.e., aluminum, is modified through the introduction of the Mg, Mn, Si, and Zr solutes.

In such an aspect, a percentage mass of Mg may be added as a solute to a base material of Al, along with other solutes in such a percentage to increase the tensile strength of the resultant alloy to above that of Al alone. The resultant alloy may have an increased tensile strength and also may have a different elongation property. For example, and not by way of limitation, the elongation may be reduced to 9%, or 8%, or may be increased up to 12%, 14,%, 16%, etc. Further, by changing the percentage of Mg included in the alloy the tensile strength of the resultant alloy may be different. For example, and not by way of limitation, increasing the percentage of Mg may increase the tensile strength to above 100 MPa, above 150 MPa, above 200 MPa, above 225 MPa, etc.

As used herein, a percentage mass of a solute in an alloy equals the mass of the solute divided by the mass of the alloy and multiplied by 100, and may be designated as “wt %”.

Formulations in various aspects of the present disclosure comprise a chemical compositions for 3D printable aluminum alloys. Compositions in accordance with the present disclosure may exhibit high strength, e.g., up to 447 MPa ultimate tensile strength, and/or high ductility, e.g., up to 18.3% elongation. In an aspect of the present disclosure, some 3D printing processes use high energy to melt the alloy (e.g., laser powder bed fusion (LPBF)) and may cause a reduction in solutes such as Mg, Li, and/or Zn due to evaporation. The tables included below include example ranges of compositions for powder/feedstock (i.e., before printing) and as printed (i.e., after printing using a high-energy process such as LPBF). However, the formulations below are not limited to before printing and as printed. Furthermore, the lines in each table may be replaced by corresponding lines in any of the other tables without restriction.

In an aspect of the present disclosure, elemental compositions in wt % in accordance with the present disclosure may comprise ranges as shown in the following tables.

TABLE 1
Powder/feedstock ranges of elemental
composition for Base Alloy 1

| | | |
|---|---|---|
| Element | Min (wt. %) | Max (wt. %) |

Base alloy 1

| Al | Balance | |
|---|---|---|
| Mg | 3.8 | 4.8 |
| Mn | 0.7 | 2.9 |
| Si | 0.1 | 0.8 |
| Zr | 0.01 | 1.0 |

L12 dispersoids 1

| | | |
|---|---|---|
| Hf | 0.01 | 0.5 |
| Li | 0.01 | 0.2 |
| Ti | 0.01 | 1.6 |
| Y | 0.01 | 0.5 |

Precipitates 1

| | | |
|---|---|---|
| Ni | 0.01 | 2.0 |
| V | 0.01 | 1.9 |
| Zn | 0.01 | 2.0 |
| Fe | 0.01 | 2.1 |
| Cu | 0.01 | 1.8 |
| Cr | 0.01 | 1.9 |
| Co | 0.01 | 2.0 |

TABLE 2
Powder/feedstock ranges of elemental
composition for Base Alloy 2

| | | |
|---|---|---|
| Element | Min (wt. %) | Max (wt. %) |

Base alloy 2

| Al | Balance | |
|---|---|---|
| Mg | 3.4 | 5.0 |
| Mn | 0.3 | 3.5 |
| Si | 0.15 | 1.1 |
| Zr | 0.01 | 1.5 |

L12 dispersoids 2

| | | |
|---|---|---|
| Hf | 0.01 | 0.50 |
| Li | 0.01 | 0.13 |
| Ti | 0.01 | 1.60 |
| Y | 0.01 | 0.50 |

Precipitates 2

| | | |
|---|---|---|
| Ni | 0.01 | 1.98 |
| V | 0.01 | 1.83 |
| Zn | 0.01 | 1.98 |
| Fe | 0.01 | 2.06 |
| Cu | 0.01 | 1.75 |
| Cr | 0.01 | 1.88 |
| Co | 0.01 | 1.98 |

TABLE 3
Powder/feedstock ranges of elemental
composition for Base Alloy 3

| | | |
|---|---|---|
| Element | Min (wt. %) | Max (wt. %) |

Base alloy 3

| Al | Balance | |
|---|---|---|
| Mg | 3.0 | 5.3 |
| Mn | 0.01 | 4.0 |
| Si | 0.1 | 1.5 |
| Zr | 0.01 | 2.0 |

L12 dispersoids 3

| | | |
|---|---|---|
| Hf | 0.01 | 0.8 |
| Li | 0.01 | 0.5 |
| Ti | 0.01 | 2.0 |
| Y | 0.01 | 1.0 |

Precipitates 3

| | | |
|---|---|---|
| Ni | 0.01 | 4.0 |
| V | 0.01 | 2.0 |
| Zn | 0.01 | 3.0 |
| Fe | 0.01 | 2.5 |
| Cu | 0.01 | 2.0 |
| Cr | 0.01 | 4.0 |
| Co | 0.01 | 4.0 |

TABLE 4
As printed ranges of elemental
composition for Base Alloy 4

| | | |
|---|---|---|
| Element | Min (wt. %) | Max (wt. %) |

Base alloy 4

| Al | Balance | |
|---|---|---|
| Mg | 3.3 | 4.3 |
| Mn | 0.7 | 2.9 |
| Si | 0.1 | 0.8 |
| Zr | 0.01 | 1.0 |

L12 dispersoids 4

| | | |
|---|---|---|
| Hf | 0.01 | 0.5 |
| Li | 0.01 | 0.1 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 1.0 |
| Fe | 0.01 | 2.1 |
| Cu | 0.01 | 1.8 |
| Cr | 0.01 | 1.9 |
| Co | 0.01 | 2.0 |

TABLE 5
As printed ranges of elemental
composition for Base Alloy 5

| | | |
|---|---|---|
| Element | Min (wt. %) | Max (wt. %) |

Base alloy 5

| Al | Balance | |
|---|---|---|
| Mg | 2.9 | 4.5 |
| Mn | 0.3 | 3.5 |
| Si | 0.15 | 1.1 |
| Zr | 0.01 | 1.5 |

L12 dispersoids 5

| | | |
|---|---|---|
| Hf | 0.01 | 0.50 |
| Li | 0.01 | 0.1 |
| Ti | 0.01 | 1.60 |
| Y | 0.01 | 0.50 |

Precipitates 5

| | | |
|---|---|---|
| Ni | 0.01 | 1.98 |
| V | 0.01 | 1.83 |
| Zn | 0.01 | 1.0 |
| Fe | 0.01 | 2.06 |
| Cu | 0.01 | 1.75 |
| Cr | 0.01 | 1.88 |
| Co | 0.01 | 1.98 |

TABLE 6
As printed ranges of elemental
composition for Base Alloy 6

| | | |
|---|---|---|
| Element | Min (wt. %) | Max (wt. %) |

Base alloy 6

| Al | Balance | |
|---|---|---|
| Mg | 2.5 | 4.8 |
| Mn | 0.01 | 4.0 |
| Si | 0.1 | 1.5 |
| Zr | 0.01 | 2.0 |

L12 dispersoids 6

| | | |
|---|---|---|
| Hf | 0.01 | 0.8 |
| Li | 0.01 | 0.25 |
| Ti | 0.01 | 2.0 |
| Y | 0.01 | 1.0 |

Precipitates 6

| | | |
|---|---|---|
| Ni | 0.01 | 4.0 |
| V | 0.01 | 2.0 |
| Zn | 0.01 | 1.5 |
| Fe | 0.01 | 2.5 |
| Cu | 0.01 | 2.0 |
| Cr | 0.01 | 4.0 |

In a further aspect of the present disclosure, elemental compositions in wt % in accordance with the present disclosure may comprise ranges as shown in the following tables.

TABLE 7
Powder/feedstock ranges of elemental
composition for Base Alloy 7

| | | |
|---|---|---|
| Element | Min (wt. %) | Max (wt. %) |

Base alloy 7

| Al | Balance | |
|---|---|---|
| Mn | 0.7 | 2.9 |
| Si | 0.1 | 0.8 |
| Zr | 0.01 | 1.0 |

and at least Ni, Fe, or Cr:

| | | |
|---|---|---|
| Ni | 3.7 | 4.1 |
| Fe | 4.0 | 4.5 |
| Cr | 3.5 | 4.0 |

L12 dispersoids 4

| | | |
|---|---|---|
| Hf | 0.01 | 0.5 |
| Li | 0.01 | 0.2 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 2.0 |
| Fe | 0.01 | 2.1 |
| Cu | 0.01 | 1.8 |
| Cr | 0.01 | 1.9 |
| Co | 0.01 | 2.0 |

TABLE 8
Powder/feedstock ranges of elemental
composition for Base Alloy 8

| | | |
|---|---|---|
| Element | Min (wt. %) | Max (wt. %) |

Base alloy 8

| Al | Balance | |
|---|---|---|
| Mn | 0.7 | 2.9 |
| Si | 0.1 | 0.8 |
| Zr | 0.01 | 1.0 |

and at least Ni, Fe, or Cr:

| | | |
|---|---|---|
| Ni | 3.0 | 5.3 |
| Fe | 3.6 | 5.2 |
| Cr | 2.4 | 4.8 |

L12 dispersoids 4

| | | |
|---|---|---|
| Hf | 0.01 | 0.5 |
| Li | 0.01 | 0.2 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 2.0 |
| Fe | 0.01 | 2.1 |
| Cu | 0.01 | 1.8 |
| Cr | 0.01 | 1.9 |
| Co | 0.01 | 2.0 |

TABLE 9
Powder/feedstock ranges of elemental
composition for Base Alloy 9

| | | |
|---|---|---|
| Element | Min (wt. %) | Max (wt. %) |

Base alloy 9

| Al | Balance | |
|---|---|---|
| Mn | 0.01 | 4.0 |
| Si | 0.1 | 1.5 |
| Zr | 0.01 | 2.0 |

and at least Ni, Fe, or Cr:

| | | |
|---|---|---|
| Ni | 2.3 | 6.5 |
| Fe | 3.3 | 6.3 |
| Cr | 1.3 | 5.5 |

L12 dispersoids 6

| | | |
|---|---|---|
| Hf | 0.01 | 0.8 |
| Li | 0.01 | 0.5 |
| Ti | 0.01 | 2.0 |
| Y | 0.01 | 1.0 |

Precipitates 6

| | | |
|---|---|---|
| Ni | 0.01 | 4.0 |
| V | 0.01 | 2.0 |
| Zn | 0.01 | 3.0 |
| Fe | 0.01 | 2.5 |
| Cu | 0.01 | 2.0 |
| Cr | 0.01 | 4.0 |
| Co | 0.01 | 4.0 |

TABLE 10
Powder/feedstock ranges of elemental
composition for Base Alloy 10

| | | |
|---|---|---|
| Element | Min (wt. %) | Max (wt. %) |

Base alloy 10

| Al | Balance | |
|---|---|---|
| Mg | 2.5 | 5.3 |
| Mn | 0.7 | 2.9 |
| Si | 0.1 | 0.8 |
| Zr | 0.01 | 1.0 |

L12 dispersoids 4

| | | |
|---|---|---|
| Hf | 0.01 | 0.5 |
| Li | 0.01 | 0.1 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 1.0 |
| Fe | 0.01 | 2.1 |
| Cu | 0.01 | 1.8 |
| Cr | 0.01 | 1.9 |
| Co | 0.01 | 2.0 |

TABLE 11
As printed ranges of elemental
composition for Base Alloy 11

| | | |
|---|---|---|
| Element | Min (wt. %) | Max (wt. %) |

Base alloy 11

| Al | Balance | |
|---|---|---|
| Mn | 0.7 | 2.9 |
| Si | 0.1 | 0.8 |
| Zr | 0.01 | 1.0 |

and at least Ni, Fe, or Cr:

| | | |
|---|---|---|
| Ni | 3.7 | 4.1 |
| Fe | 4.0 | 4.5 |
| Cr | 3.5 | 4.0 |

L12 dispersoids 4

| | | |
|---|---|---|
| Hf | 0.01 | 0.5 |
| Li | 0.01 | 0.1 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 1.0 |
| Fe | 0.01 | 2.1 |
| Cu | 0.01 | 1.8 |
| Cr | 0.01 | 1.9 |
| Co | 0.01 | 2.0 |

TABLE 12
As printed ranges of elemental
composition for Base Alloy 12

| | | |
|---|---|---|
| Element | Min (wt. %) | Max (wt. %) |

Base alloy 12

| Al | Balance | |
|---|---|---|
| Mn | 0.7 | 2.9 |
| Si | 0.1 | 0.8 |
| Zr | 0.01 | 1.0 |

and at least Ni, Fe, or Cr:

| | | |
|---|---|---|
| Ni | 3.0 | 5.3 |
| Fe | 3.6 | 5.2 |
| Cr | 2.4 | 4.8 |

L12 dispersoids 4

| | | |
|---|---|---|
| Hf | 0.01 | 0.5 |
| Li | 0.01 | 0.1 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 1.0 |
| Fe | 0.01 | 2.1 |
| Cu | 0.01 | 1.8 |
| Cr | 0.01 | 1.9 |
| Co | 0.01 | 2.0 |

TABLE 13
As printed ranges of elemental
composition for Base Alloy 13

| | | |
|---|---|---|
| Element | Min (wt. %) | Max (wt. %) |

Base alloy 13

| Al | Balance | |
|---|---|---|
| Mn | 0.01 | 4.0 |
| Si | 0.1 | 1.5 |
| Zr | 0.01 | 2.0 |
| Ni | 2.3 | 6.5 |
| Fe | 3.3 | 6.3 |
| Cr | 1.3 | 5.5 |

L12 dispersoids 6

| | | |
|---|---|---|
| Hf | 0.01 | 0.8 |
| Li | 0.01 | 0.25 |
| Ti | 0.01 | 2.0 |
| Y | 0.01 | 1.0 |

Precipitates 6

| | | |
|---|---|---|
| Ni | 0.01 | 4.0 |
| V | 0.01 | 2.0 |
| Zn | 0.01 | 1.5 |
| Fe | 0.01 | 2.5 |
| Cu | 0.01 | 2.0 |
| Cr | 0.01 | 4.0 |
| Co | 0.01 | 4.0 |

TABLE 14
As printed ranges of elemental
composition for Base Alloy 14

| | | |
|---|---|---|
| Element | Min (wt. %) | Max (wt. %) |

Base alloy 14

| Al | Balance | |
|---|---|---|
| Mg | 2.0 | 4.8 |
| Mn | 0.7 | 2.9 |
| Si | 0.1 | 0.8 |
| Zr | 0.01 | 1.0 |

L12 dispersoids 4

| | | |
|---|---|---|
| Hf | 0.01 | 0.5 |
| Li | 0.01 | 0.1 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zn | 0.01 | 1.0 |
| Fe | 0.01 | 2.1 |
| Cu | 0.01 | 1.8 |
| Cr | 0.01 | 1.9 |
| Co | 0.01 | 2.0 |

In yet a further aspect of the present disclosure, elemental compositions in wt % in accordance with the present disclosure may comprise ranges as shown in the following table.

TABLE 15
Powder/feedstock ranges of elemental
composition for Base Alloy 15

| | | |
|---|---|---|
| Element | Min (wt. %) | Max (wt. %) |

Base alloy 15

| Al | Balance | |
|---|---|---|
| Mn | 0.01 | 2.9 |
| Si | 0.01 | 3.9 |
| Zr | 0.01 | 2.8 |
| Ni | 3.0 | 5.3 |
| Fe | 3.6 | 5.2 |
| Cr | 2.4 | 4.8 |

L12 dispersoids 4

| | | |
|---|---|---|
| Hf | 0.01 | 0.5 |
| Li | 0.01 | 0.1 |
| Ti | 0.01 | 1.6 |
| Y | 0.01 | 0.5 |

Precipitates 4

| | | |
|---|---|---|
| Ni | 0.01 | 2.0 |
| V | 0.01 | 1.9 |
| Zr | 0.01 | 1.0 |
| Fe | 0.01 | 2.1 |
| Cu | 0.01 | 1.8 |
| Cr | 0.01 | 1.9 |
| Co | 0.01 | 2.0 |

In an aspect of the present disclosure, addition of the above solutes, as well as the dispersoids and precipitates, may change the tensile strength of Al as the base material by altering the alloy structure through at least solid solution strengthening. Depending on which base material(s) and/or other solutes are used in the resultant alloy, Mg may also change the strength of the resultant alloy through one or more of work hardening, precipitation hardening, dispersion strengthening, grain boundary strengthening, and/or transformation strengthening without departing from the scope of the present disclosure. In an aspect of the present disclosure, these solutes may act as substitutional solutes and/or interstitial solutes.

Magnesium

In an aspect of the present disclosure, Mg may be added to the alloy in a proportion of 2.0-5.3 wt % for the resultant alloy. Mg may be added in other proportions, e.g., a proportion of 3.0-5.3 wt % for the resultant alloy, 3.8-4.8 wt %, 3.4-5.0 wt %, 2.5-4.8 wt %, 3.2-5.4 wt %, 3.3-4.3 wt %, 2.9-4.5 wt %, 2.5-4.8 wt %, 3.8-4.8 wt %, 2.0-4.8 wt %, etc., or any range between 2.0 and 5.3 wt %, and/or as disclosed herein or in the tables herein, without departing from the scope of the present disclosure. Other proportions of Mg may also be used, depending on which other solutes are included in the resultant alloy, without departing from the scope of the present disclosure.

In an aspect of the present disclosure, a percentage mass of Mg may be added as a solute to Al as the base material and other solutes in such a percentage to increase the tensile strength of the resultant alloy, through alterations to the alloy structure of the resultant alloy, to above that of Al alone while retaining or increasing the elongation of aluminum alone. In an aspect of the present disclosure, Mg may be added to the alloy in a proportion of 2.0-5.3 wt %, and may change the elongation and tensile strength properties of the resultant alloy.

Manganese

In an aspect of the present disclosure, Mn may be added to the alloy in a proportion of 0.01-4.0 wt % for the resultant alloy. Mn may be added in other proportions, e.g., a proportion of 0.3-3.5 wt % for the resultant alloy, 0.7-2.9 wt %, 0.01-4.0 wt %, 0.3-2.0 wt %, 0.3-1.0 wt %, 0.1-4.0 wt %, etc., or any range between 0.01 and 4.0 wt % as disclosed herein or in the tables herein, without departing from the scope of the present disclosure. Other proportions of Mn may also be used, depending on which other solutes are included in the resultant alloy, without departing from the scope of the present disclosure.

In an aspect of the present disclosure, a percentage mass of Mn may be added as a solute to Al as the base material and other solutes in such a percentage to increase the tensile strength of the resultant alloy, through alterations to the alloy structure of the resultant alloy, to above that of Al alone while retaining or increasing the elongation of aluminum alone. In an aspect of the present disclosure, Mn may be added to the alloy in a proportion of 0.01-4.0 wt %, and may change the elongation and tensile strength properties of the resultant alloy.

Silicon

In an aspect of the present disclosure, Si may be added to the alloy in a proportion of 0.1-1.5 wt % for the resultant alloy. Si may be added in other proportions, e.g., a proportion of 0.1-0.8 wt % for the resultant alloy, 0.15-1.1 wt %, 0.15-1.5 wt %, 0.1-1.5 wt %, 0.2-1.0 wt %, etc., or any range between 0.1 and 1.5 wt % as disclosed herein or in the tables herein, without departing from the scope of the present disclosure. Other proportions of Si may also be used, depending on which other solutes are included in the resultant alloy, without departing from the scope of the present disclosure.

In an aspect of the present disclosure, a percentage mass of Si may be added as a solute to Al as the base material and other solutes in such a percentage to increase the tensile strength of the resultant alloy, through alterations to the alloy structure of the resultant alloy, to above that of Al alone while retaining or increasing the elongation of aluminum alone. In an aspect of the present disclosure, Si may be added to the alloy in a proportion of 0.1-1.5 wt %, and may change the elongation and tensile strength properties of the resultant alloy.

Zirconium

In an aspect of the present disclosure, Zr may be added to the alloy in a proportion of 0.01-2.0 wt % for the resultant alloy. Zr may be added in other proportions, e.g., a proportion of 0.01-1.0 wt % for the resultant alloy, 0.01-1.5 wt %, 0.01-2.0 wt %, 0.5-2.0 wt %, 0.5-1.5 wt %, 0.01-2.0 wt %, etc., without departing from the scope of the present disclosure. Other proportions of Zr may also be used, depending on which other solutes are included in the resultant alloy, without departing from the scope of the present disclosure.

In an aspect of the present disclosure, a percentage mass of Zr may be added as a solute to Al as the base material and other solutes in such a percentage to increase the tensile strength of the resultant alloy, through alterations to the alloy structure of the resultant alloy, to above that of Al alone while retaining or increasing the elongation of aluminum alone. In an aspect of the present disclosure, Zr may be added to the alloy in a proportion of 0.01-2.0 wt %, and may change the elongation and tensile strength properties of the resultant alloy.

In an aspect of the present disclosure, an alloy of Al as the base material with Mg, Mn, Si, and Zr as solutes may be referred to as a “base alloy” herein. This base alloy may serve as a baseline mixture for other alloys. Additional solutes may be included in this alloy, and/or the wt % of Mg, Mn, Si, and/or Zr may be altered for inclusion of other solutes. Such alloys are described herein as being within the scope of the present disclosure. The base alloy may be a mixture of Mg, Mn, Si, and/or Zr with other base materials, e.g., cobalt, iron, etc., without departing from the scope of the present disclosure.

For example, and not by way of limitation, a base alloy in accordance with an aspect of the present disclosure may include Mg in the range of 2.0-5.3 wt %, Mn in the range of 0.01-4.0 wt %, Si in the range of 0.01 to 1.5 wt %, Zr in the range of 0.01-2.0 wt %, and one or more base materials, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

In another example, and not by way of limitation, a base alloy in accordance with an aspect of the present disclosure may include Mn in the range of 0.01-4.0 wt %, Si in the range of 0.01 to 1.5 wt %, Zr in the range of 0.01-2.0 wt %, and one or more base materials, e.g., aluminum, as the balance of the alloy. Thus, in various embodiments, a base alloy might not include Mg. The weight percentage ranges described herein may be altered as desired within the specified ranges. Although a base material may include a combination of materials, in an aspect of the present disclosure the base material may be a single material, e.g., aluminum, iron, cobalt, etc.

Hafnium

In an aspect of the present disclosure, a percentage mass of hafnium (Hf) may be added as a solute to the base alloy of Al, Mg, Mn, Si, and Zr or the base alloy of Al, Mn, Si, and Zr described herein. The inclusion of Hf as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Hf in the range of 0.01-0.8 wt %, 0.01-0.5 wt %, or any range between 0.01 and 0.8 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Hf may also include other solutes, dispersoids, and/or precipitates as described herein without departing from the scope of the present disclosure.

Lithium

In an aspect of the present disclosure, a percentage mass of lithium (Li) may be added as a solute to the base alloy of Al, Mg, Mn, Si, and Zr or the base alloy of Al, Mn, Si, and Zr described herein. The inclusion of Li as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Li in the range of 0.01-0.5 wt %, 0.01-0.2 wt %, 0.01-0.1 wt %, 0.01-0.25 wt %, or any range between 0.01 and 1.0 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Li may also include other solutes, dispersoids, and/or precipitates as described herein without departing from the scope of the present disclosure.

Titanium

In an aspect of the present disclosure, a percentage mass of titanium (Ti) may be added as a solute to the base alloy of Al, Mg, Mn, Si, and Zr or the base alloy of Al, Mn, Si, and Zr described herein. The inclusion of Ti as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Ti in the range of 0.01-2.0 wt %, 0.01-1.6 wt %, 0.01-0.2 wt %, 0.01-1.5 wt %, 0.01-1.0 wt %, or any range between 0.01 and 2.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Ti may also include other solutes, dispersoids, and/or precipitates as described herein without departing from the scope of the present disclosure.

Yttrium

In an aspect of the present disclosure, a percentage mass of yttrium (Y) may be added as a solute to the base alloy of Al, Mg, Mn, Si, and Zr or the base alloy of Al, Mn, Si, and Zr described herein. The inclusion of Y as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Y in the range of 0.01-1.0 wt %, 0.01-0.5 wt %, 0.01-0.2 wt %, 0.01-0.1 wt %, 0.01-0.25 wt %, or any range between 0.01 and 1.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Y may also include other solutes, dispersoids, and/or precipitates as described herein without departing from the scope of the present disclosure.

Nickel

In an aspect of the present disclosure, a percentage mass of nickel (Ni) may be added as a solute to the base alloy of Al, Mg, Mn, Si, and Zr or the base alloy of Al, Mn, Si, and Zr described herein. The inclusion of Ni as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Ni in the range of 0.01-4.0 wt %, 0.01-1.98 wt %, 0.01-2.0 wt %, 0.01-0.1 wt %, 0.01-3.0 wt %, or any range between 0.01 and 4.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Ni may also include other solutes, dispersoids, and/or precipitates as described herein without departing from the scope of the present disclosure.

Vanadium

In an aspect of the present disclosure, a percentage mass of vanadium (V) may be added as a solute to the base alloy of Al, Mg, Mn, Si, and Zr or the base alloy of Al, Mn, Si, and Zr described herein. The inclusion of V as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of V in the range of 0.01-2.0 wt %, 0.01-1.9 wt %, 0.01-1.83 wt %, 0.01-1.9 wt %, 0.01-1.25 wt %, or any range between 0.01 and 2.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes V may also include other solutes, dispersoids, and/or precipitates as described herein without departing from the scope of the present disclosure.

Zinc

In an aspect of the present disclosure, a percentage mass of zinc (Zn) may be added as a solute to the base alloy of Al, Mg, Mn, Si, and Zr or the base alloy of Al, Mn, Si, and Zr described herein. The inclusion of Zn as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Zn in the range of 0.01-3.0 wt %, 0.01-2.0 wt %, 0.01-1.98 wt %, 0.01-1.0 wt %, 0.01-1.5 wt %, or any range between 0.01 and 3.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Zn may also include other solutes, dispersoids, and/or precipitates as described herein without departing from the scope of the present disclosure.

Iron

In an aspect of the present disclosure, a percentage mass of iron (Fe) may be added as a solute to the base alloy of Al, Mg, Mn, Si, and Zr or the base alloy of Al, Mn, Si, and Zr described herein. The inclusion of Fe as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Fe in the range of 0.01-2.5 wt %, 0.01-2.1 wt %, 0.01-2.06 wt %, 0.01-2.0 wt %, 0.01-1.5 wt %, or any range between 0.01 and 3.0 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Fe may also include other solutes, dispersoids, and/or precipitates as described herein without departing from the scope of the present disclosure.

Copper

In an aspect of the present disclosure, a percentage mass of copper (Cu) may be added as a solute to the base alloy of Al, Mg, Mn, Si, and Zr or the base alloy of Al, Mn, Si, and Zr described herein. The inclusion of Cu as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Cu in the range of 0.01-2.0 wt %, 0.01-1.8 wt %, 0.01-1.75 wt %, 0.01-4.0 wt %, 0.01-0.25 wt %, or any range between 0.01 and 4.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Cu may also include other solutes, dispersoids, and/or precipitates as described herein without departing from the scope of the present disclosure.

Chromium

In an aspect of the present disclosure, a percentage mass of chromium (Cr) may be added as a solute to the base alloy of Al, Mg, Mn, Si, and Zr or the base alloy of Al, Mn, Si, and Zr described herein. The inclusion of Cr as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Cr in the range of 0.01-4.0 wt %, 0.01-1.9 wt %, 0.01-1.88 wt %, 0.01-1.85 wt %, 0.01-3.2 wt %, or any range between 0.01 and 4.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Cr may also include other solutes, dispersoids, and/or precipitates as described herein without departing from the scope of the present disclosure.

Cobalt

In an aspect of the present disclosure, a percentage mass of cobalt (Co) may be added as a solute to the base alloy of Al, Mg, Mn, Si, and Zr or the base alloy of Al, Mn, Si, and Zr described herein. The inclusion of Co as a solute to the base alloy may also allow for the increase in the tensile strength of the resultant alloy, through alterations to the alloy structure of the resultant alloy, to above that of the base alloy, as well as changing the elongation properties of the resultant alloy.

For example, and not by way of limitation, an alloy in accordance with an aspect of the present disclosure may include the base alloy solutes Mg in the range of 2.0-5.3 wt %, Mn in the range of 0.01-4.0 wt %, Si in the range of 0.01 to 1.5 wt %, Zr in the range of 0.01-2.0 wt %, (or a base alloy that does not include Mg, as described above), with the addition of Co in the range of 0.01-4.0 wt %, 0.01-2.0 wt %, 0.01-1.98 wt %, 0.01-2.1 wt %, 0.01-1.73 wt %, or any range between 0.01 and 4.5 wt %, and a base material, e.g., aluminum, as the balance of the alloy. The weight percentage ranges described herein may be altered as desired within the specified ranges. Although a base material may include a combination of materials, in an aspect of the present disclosure the base material may be a single material, e.g., aluminum, iron, cobalt, etc.

A base alloy of Mg—Mn—Si—Zr or a base alloy of Mn—Si—Zr that includes Co may also include other solutes, dispersoids, and/or precipitates as described herein without departing from the scope of the present disclosure.

The base alloy of the present disclosure, either with or without the additional optional solutes described herein, may have an elongation value that is greater than that of aluminum alone. For example, and not by way of limitation, the base alloy, with or without the additional optional solutes described herein, may have an elongation value of at least 12%. The elongation may be at least 13%, at least 14%, at least 15%, at least 16%, at least 17%, at least 18%, at least 19%, or other values between 12% and 19% without departing from the scope of the present disclosure. Further, the elongation values described herein may be as-printed values, when the alloy is produced from powders in an AM process.

The base alloy of the present disclosure, either with or without the additional optional solutes described herein, may have an ultimate tensile strength that is greater than that of aluminum alone. For example, and not by way of limitation, the base alloy, with or without the additional optional solutes described herein, may have an ultimate tensile strength of at least 350 megapascals. The ultimate tensile strength may be at least 375 megapascals, 400 megapascals, 425 megapascals, 430 megapascals, 435 megapascals, 440 megapascals, or at least 445 megapascals, or other values between 350 and 445 megapascals without departing from the scope of the present disclosure. Further, the ultimate tensile strength values described herein may be as-printed values, when the alloy is produced from powders in an AM process.

Combination with other Aluminum Alloys

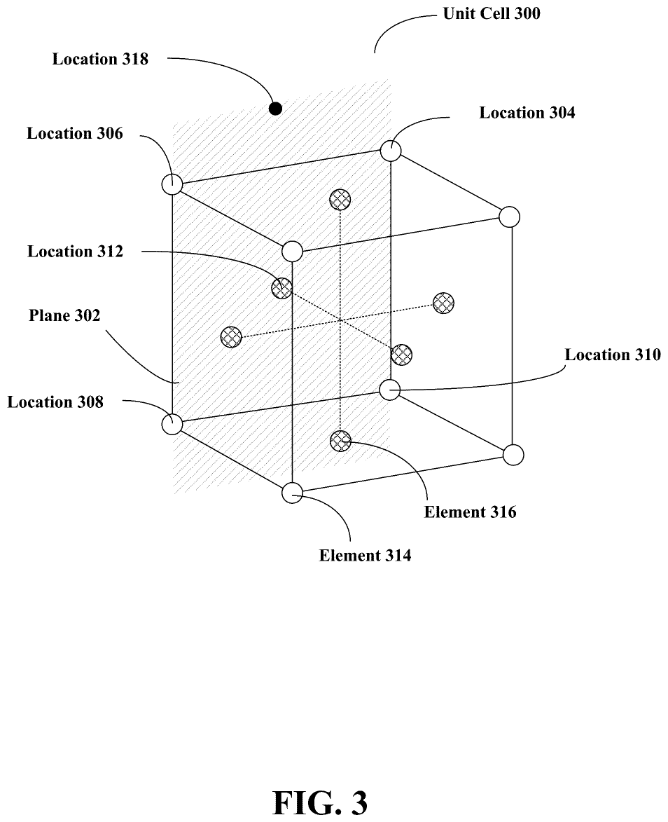

FIG. 3 illustrates a unit cell of a structure in accordance with an aspect of the present disclosure.

Unit cell 300 shows a single cube of an alloy structure, which, as illustrated in FIG. 3, is a face centered cubic (fcc) structure. For ease of understanding plane 302 is shown, although unit cell 300 has six planes that are approximately perpendicular to each other at each intersection. Other unit cells 300 are possible, e.g., bcc, cubic, hcp, etc., without departing from the scope of the present disclosure.

Plane 302 is described by five atomic locations: location 304, location 306, location 308, and location 310, which define the “corners” of plane 302, and location 312, which defines the “center” of plane 302 within the face of the unit cell closest to the viewer. In an alloy structure, one unit cell 300 may be adjacent to another unit cell 300, etc., such that a large array of unit cells 300 defines the alloy structure.

An element 314 is located in this example at each of the corners of unit cell 300, including at locations 304, 306, 308, and 310 of plane 302. An element 316 is located at the center of each one of the six planes, including at location 312. That is, as shown in FIG. 3, locations 304-310 are occupied by element 314, and location 312 is occupied by element 316. Element 314 may be the same material/element as element 316, or may be a different material/element depending on the composition of the resultant alloy. In an alloy structure with unit cells 300 of a pure material, e.g., aluminum, each location 304-310 and location 312 would be occupied by aluminum. If a substitutional solute were introduced as an alloying material for pure aluminum, then one or more locations 304-312 may be occupied by the alloying material, e.g., vanadium, chromium, etc. If an interstitial solute were added as an alloying material for pure aluminum, such a solute may be located, for example, location 318. Location 318 is between location 306 and location 304, and in an aspect of the present disclosure, within plane 302. Other locations for an interstitial solute are possible without departing from the scope of the present disclosure.

Aluminum, which has an fcc unit cell as shown in FIG. 3, has been alloyed with various solutes. Some aluminum alloys have been standardized and named based on which solute(s) are included in the named alloy. For example, and not by way of limitation, the International Alloy Designation System (IADS) is a widely-accepted naming scheme for aluminum alloys, where each alloy is referred to using a four-digit number. The first digit of the number indicates the major solute elements included in the alloy. The second digit indicates any variants for that solute alloy, and the third and fourth digits identify a specific alloy in that series.

For aluminum alloys named (i.e., numbered) in the IADS, 1000 series alloys are essentially pure aluminum content by wt %, and the other digits represent various applications for such alloys. 2000 series aluminum alloys are alloyed with Cu, 3000 series aluminum alloys are alloyed with Mn, 4000 series aluminum alloys are alloyed with silicon (Si), 5000 series aluminum alloys are alloyed with Mg, 6000 series aluminum alloys are alloyed with Mg and Si, 7000 series aluminum alloys are alloyed with Zn, and 8000 series aluminum alloys are alloyed with other elements or a combination of elements that are not covered by other series designations. As an example, and not by way of limitation, a common aluminum alloy is referred to as “6061” which, per the IADS naming scheme, has Mg and Si as the major alloying solutes. However, 6061 has other alloying solutes, in various percentages, e.g., iron (Fe), copper (Cu), chromium (Cr), zinc (Zn), titanium (Ti), and manganese (Mn), and is allowed to have other solutes, which may be referred to as “impurities,” of less than a certain percentage. The solutes present in 6061 may have a range of wt % depending on the application, manufacturer, alloying tolerances, and/or other reasons.

However, when the manufacturing process of creating such alloys is changed from smelting, forging, and/or casting to 3-D printing, the formation of the alloy structure and/or unit cells 300 within the alloy structure becomes localized. Since 3-D printing only applies thermal energy to a small portion of the overall alloy structure at any given time, the formation of unit cells 300 happens on a local scale in a build piece 109 instead of on a global scale, for example, in a cast piece. As a result of the local versus global thermal energy application, and local versus global cooling of the build piece 109, it has been seen that some named, common alloys of aluminum are difficult to 3-D print without introducing micro-fractures and/or other deleterious structural defects in the build piece 109.

In an aspect of the present disclosure, any one or more of the alloys described herein may be combined with a known aluminum alloy, e.g., combined with alloy 2195, alloy 2218, alloy 2519, alloy 6060, alloy 6061, alloy 7010, etc., which may allow for 3-D printing of an aluminum alloy that is difficult to 3-D print. For example, and not by way of limitation, powdered forms of alloy 6061 (or any other IADS named alloy) and an alloy described in accordance with an aspect of the present disclosure may be mixed together and placed into hopper 115, and the build process described in FIGS. 1A-1E of the present disclosure may be undertaken for that combination of alloys, which can create a new alloy when fused. In such an aspect, a mixed metal composite, hybrid alloy, and/or quasi-alloy that may have similar characteristics to the IADS numbered alloy may be created.

In an aspect of the present disclosure, when such an alloy is 3D printed as described with respect to FIGS. 1A-1E, some of the solutes in the powder 117 used to create the resultant alloy may be vaporized and/or otherwise removed from the resultant alloy without departing from the scope of the present disclosure. In such an aspect, the percentages of individual solutes and/or base materials may change from those used in the powder 117. In such an aspect, the percentages described herein may refer to the final percentages of base materials and/or solutes in the final printed material and/or may describe the percentages of base materials and/or solutes in the powder 117.

In an aspect of the present disclosure, different percentages of each alloy powder material may be used, e.g., one embodiment can include 50% base alloy of the present disclosure and 50% alloy 2195, another embodiment can include 25% base alloy of the present disclosure, 25% alloy 6061, 25% Ti—V alloy of the present disclosure, and 25% of another alloy, etc.

For example, and not by way of limitation, in an aspect of the present disclosure, alloy 2195 may be combined with one or more alloys described herein. Alloy 2195 is a relatively complex alloy, in that there are a number of solutes included in alloy 2195. In being consistent with the IADS naming schedule, alloy 2195 has Cu as a major alloying solute. However, alloy 2195 may also include, for example, lithium (Li), magnesium (Mg), silver (Ag), zirconium (Zr), iron (Fe), silicon (Si), and zinc (Zn) at or below certain wt % of the final alloy material, and other residual solutes at less than a certain wt % of the final alloy material, while still retaining the moniker “alloy 2195.” The total percentage of solutes in such combination of alloy 2195 and one or more alloys described herein may have a maximum wt % of the overall alloy, e.g., no more than 20%, no more than 10%, no more than 9%, no more than 8%, no more than 7%, etc., without departing from the scope of the present disclosure.

In an aspect of the present disclosure, powders, oxides, components, and/or precursors of elements included in the base alloy (i.e., an alloy of Al as the base material with Mg, Zr, and Mn as solutes, and having a tensile strength of above 80 MPa and an elongation of at least 10%) may be mixed with powders of the base material and solutes of alloy 2195 such that this mixture of powders can be printed using 3-D printing techniques such as those described in FIGS. 1A-1E of the present disclosure. The percentages of the base alloy and alloy 2195 may be varied in different mixtures of powder 117, e.g., one mixture of powder 117 may include 50% base alloy powder 117 and 50% alloy 2195 powder, another mixture of powder 117 may include 25% base alloy powder 117 and 75% alloy 2195 powder, yet another mixture of powder 117 may include 10% base alloy powder 117 and 90% alloy 2195 powder 117, etc., without departing from the scope of the present disclosure. The total percentage of all of the solutes may have a maximum wt % of the overall alloy, e.g., no more than 40 wt %, no more than 30 wt %, no more than 20 wt %, no more than 10 wt %, no more than 9 wt %, etc., without departing from the scope of the present disclosure.

In an aspect of the present disclosure, the blending of base alloy powder 117 and alloy 2195 powder 117 into a homogenous mixture may allow for 3-D printing resulting in an alloy that is a combination of the base alloy and alloy 2195. Depending on the percentages of base alloy and alloy 2195 that are combined in the resultant alloy, the strength and/or ductility of the final material may be similar to alloy 2195, and thus, the resultant alloy may allow for an alloy similar to alloy 2195 in terms of performance characteristics to be 3-D printed.

In another aspect of the present disclosure, base alloy may be blended with multiple IADS named alloys, such that the performance characteristics of the final material may be tailored to a given application. Many possibilities of blending of alloys in powder form to create a combination powder 117 using the base alloy of the present disclosure, variants of the base alloy of the present disclosure, and IADS-named alloys are possible within the scope of the present disclosure.

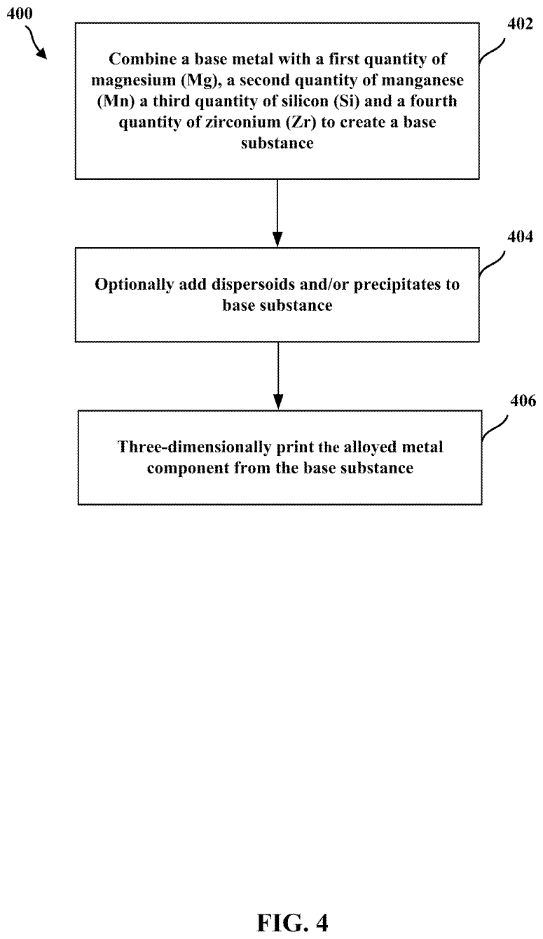

FIG. 4 shows a flow diagram illustrating an exemplary method 400 for additively manufacturing a component in accordance with an aspect of the present disclosure.

The additive manufacturing may be three-dimensional printing, or may be another additive manufacturing process. The objects that perform, at least in part, the exemplary functions of FIG. 4 may include, for example, computer 150 and one or more components therein, a three-dimensional printer, such as illustrated in FIGS. 1A-E, and other objects that may be used for forming the above-referenced materials.

It should be understood that the steps identified in FIG. 4 are exemplary in nature, and a different order or sequence of steps, and additional or alternative steps, may be undertaken as contemplated in this disclosure to arrive at a similar result.

At 402, a base metal may be combined with a first quantity of magnesium (Mg), a second quantity of manganese (Mn), a third quantity of silicon (Si), and a fourth quantity of zirconium (Zr) to create a base substance. The base metal may be aluminum (Al) or other single-element material, or may be a combination of elements and/or materials. In various embodiments, the first quantity of Mg might be zero, i.e., the alloy might not contain Mg, but contains Mn, Si, and Zr.

At 404, dispersoids and/or precipitates may optionally be added to the base substance. Dispersoids and precipitates may include Hf, Li, Ti, Y, Ni, V, Zn, Fe, Cu, Cr, and/or Co.

At 406, the alloyed metal component is three-dimensionally printed the from the base substance, wherein the base material produces a structure in the alloyed metal component.

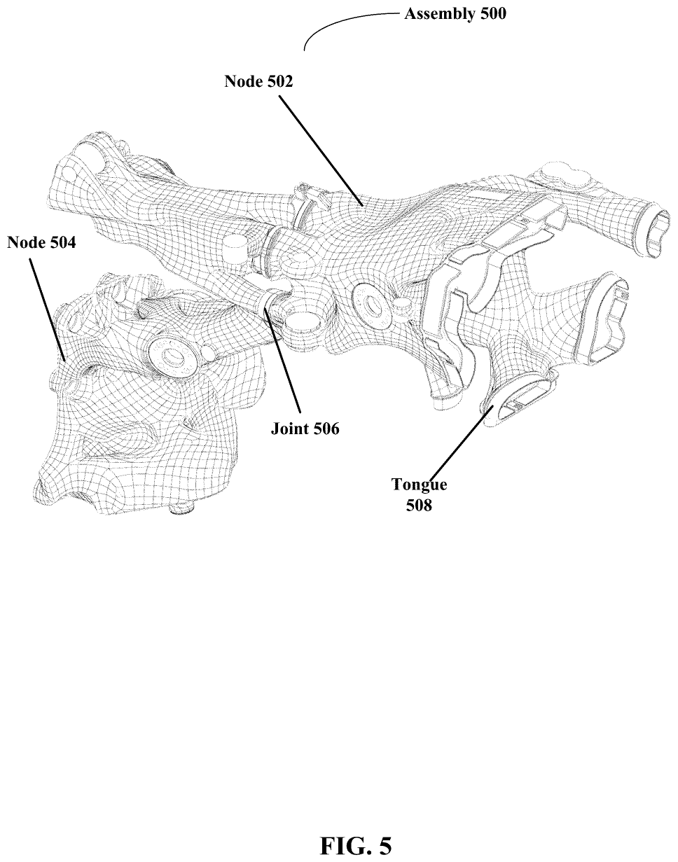

FIG. 5 illustrates an assembly in accordance with an aspect of the present disclosure.

FIG. 5 illustrates assembly 500, which includes at least node 502 and node 504. Node 502 and node 504 are coupled at one or more joints 506. Joint 506 may include various types of structures, one of which is shown as tongue 508 in FIG. 5.

In an aspect of the present disclosure, additive manufacturing allows for manufacturing of complex structures, such as node 502, node 504, etc., for vehicle structures. In such an aspect, multi-part nodes are additively manufactured and then may be coupled together, either through manual assembly or in an automated assembly cell, to form assembly 500. In alternate embodiments, the alloys described herein may be used to additively manufacture integrated components, such as heat exchangers.

In an aspect of the present disclosure, vehicle assemblies, subassemblies, etc. may be additively manufactured. These assemblies, subassemblies, etc., may be combined with other components, parts, etc., to create a larger assembly such as a vehicle. As shown in FIG. 5, an aspect of the present disclosure may include a rear frame for a vehicle. Such a rear frame assembly 500 may include nodes 502 and 504, that are coupled together at one or more joints 506. Such joints 506 may also include tongue 508 that is coupled to a groove in an adjoining node. The joints 506 may incorporate one or more structural adhesives to structurally couple joint 506.

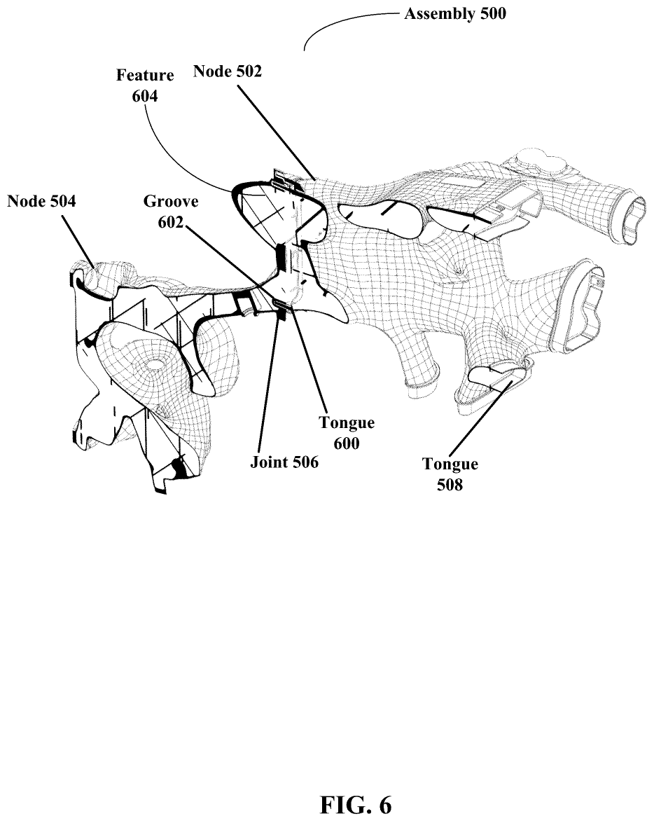

FIG. 6 illustrates a cross-sectional view of an assembly in accordance with an aspect of the present disclosure.

As shown in FIG. 6, joint 506 may include a tongue 600 from one node, in this example node 502, and a groove 602 in another node, in this example node 504. Tongue 600 and groove 602 may allow for alignment and/or coupling of node 502 to node 504. Further, a given node may have both tongues 600 and grooves 602 to make the manufacturing process and/or assembly process of assembly 500 easier and/or more efficient.

In an aspect of the present disclosure, nodes 502 and 504 may be manufactured using additive manufacturing techniques, using one or more of the alloys described herein. Additive manufacturing of nodes 502 and/or 504 may allow nodes 502 and/or 504 to incorporate one or more features 604 that may be prohibitively expensive or difficult to manufacture using other manufacturing techniques.

In an aspect of the present disclosure, feature 604 may provide strength, stiffening, directional compression and/or expansion of a given node. Feature 604 may be made of a different alloy than that of the node that feature 604 is part of, such that the overall assembly may be less expensive to produce, less expensive for the materials cost, more efficient to produce, etc. Feature 604 may extend inward towards an interior of a node 502/504, may be an exterior feature of a node 502/504, or may be an interior and exterior feature of a node 502/504. Further, feature 604 may extend through the thickness of a given node 502/504 without departing from the scope of the present disclosure. In some embodiments, feature 604 may additionally be self-supporting, i.e., printed without support structures during the additive manufacturing process.

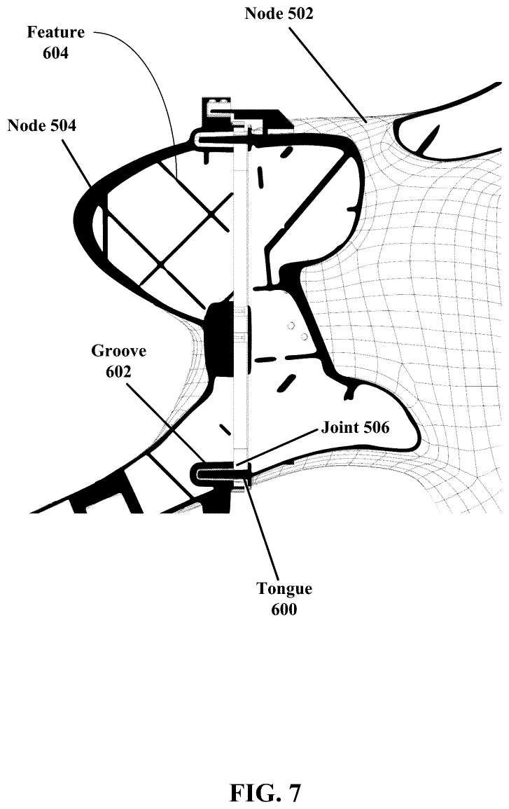

FIG. 7 illustrates a joint feature of an assembly in accordance with an aspect of the present disclosure.

As shown in FIG. 7, tongue 600 is coupled to groove 602 at joint 506. In an aspect of the present disclosure, tongue 600 may be made from a different alloy than that of node 502. In an aspect of the present disclosure, groove 602 may be made from a different alloy than that of node 504. In an aspect of the present disclosure, tongue 600 may be designed to have a gap between tongue 600 and groove 602 when node 502 is coupled to node 504, such that an adhesive or other material may be placed in between tongue 600 and groove 602. The material used may be a structural adhesive, and may have similar structural properties to the alloys used to create node 502, node 504, tongue 600, and/or groove 602. The material may also be a curable adhesive, such as an ultraviolet (UV) curable adhesive.

In an aspect of the present disclosure, feature 604 may be an “egg crate” feature, which may act as a stiffening member, structural component, or directional strength portion of a given node. For example, and not by way of limitation, feature 604 may be oriented on node 504 such that node 504 will compress in a given direction and/or fashion, and resist compression in another direction and/or fashion. Such features 604 may be advantageous in vehicle design, such that a given node will compress in a known direction and resist compression in other directions during a vehicle crash, to protect occupants of the vehicle. Feature 604 may also provide aerodynamic flow, either internal to a node and/or external to a node, as well as provide other characteristics for a given node, without departing from the scope of the present disclosure.

The previous description is provided to enable any person skilled in the art to practice the various aspects described herein. Various modifications to these exemplary embodiments presented throughout this disclosure will be readily apparent to those skilled in the art, and the concepts disclosed herein may be applied in other ways than the examples disclosed herein. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An additive manufacturing alloy comprising:
magnesium (Mg) that is between 2.5 and 5.3% by weight;
manganese (Mn) that is between 0.01 and 4.0% by weight;
silicon (Si) that is between 0.1 and 1.5% by weight;
zirconium (Zr) that is between 0.01 and 2.0% by weight; and
aluminum (Al).

2. The additive manufacturing alloy of claim 1, further comprising at least:
hafnium (Hf), lithium (Li), titanium (Ti), or yttrium (Y).

3. The additive manufacturing alloy of claim 2, wherein:
Hf is between 0.01 and 0.8% by weight;
Li is between 0.01 and 0.5% by weight;
Ti is between 0.01 and 2.0% by weight; and
Y is between 0.01 and 1.0% by weight.

4. The additive manufacturing alloy of claim 1, further comprising at least:
nickel (Ni), vanadium (V), zinc (Zn), iron (Fe), copper (Cu), chromium (Cr), or cobalt (Co).

5. The additive manufacturing alloy of claim 4, wherein:
Ni is between 0.01 and 4.0% by weight;
V is between 0.01 and 2.0% by weight;
Zn is between 0.01 and 3.0% by weight;
Fe is between 0.01 and 2.5% by weight;
Cu is between 0.01 and 2.0% by weight;
Cr is between 0.01 and 4.0% by weight; and
Co is between 0.01 and 4.0% by weight.

6. The additive manufacturing alloy of claim 1, wherein an elongation of an as-printed alloy is at least 15%.

7. The additive manufacturing alloy of claim 1, wherein an elongation of an as-printed alloy is at least 17%.

8. The additive manufacturing alloy of claim 1, wherein an elongation of an as-printed alloy is at least 18%.

9. The additive manufacturing alloy of claim 1, wherein an ultimate tensile strength of an as-printed alloy is at least 400 megapascals.

10. The additive manufacturing alloy of claim 1, wherein an ultimate tensile strength of an as-printed alloy is at least 425 megapascals.

11. The additive manufacturing alloy of claim 1, wherein an ultimate tensile strength of an as-printed alloy is at least 440 megapascals.

12. The additive manufacturing alloy of claim 1, wherein an ultimate tensile strength of an as-printed alloy is at least 445 megapascals.

13. An additive manufacturing alloy comprising:
magnesium (Mg) in a range from 2.0 to 5.3% by weight;
manganese (Mn) in a range from 0.7 to 2.9% by weight;
silicon (Si) in a range from 0.1 to 0.8% by weight; and
zirconium (Zr) in a range from 0.01 to 1.0% by weight; and
aluminum (Al).

14. The additive manufacturing alloy of claim 13, further comprising at least:
hafnium (Hf), lithium (Li), titanium (Ti), or yttrium (Y).

15. The additive manufacturing alloy of claim 14, wherein:
Hf is between 0.01 and 0.8% by weight;
Li is between 0.01 and 0.5% by weight;
Ti is between 0.01 and 2.0% by weight; and
Y is between 0.01 and 1.0% by weight.

16. The additive manufacturing alloy of claim 13, further comprising at least:
nickel (Ni), vanadium (V), zinc (Zn), iron (Fe), copper (Cu), chromium (Cr), or cobalt (Co).

17. The additive manufacturing alloy of claim 16, wherein:
Ni is between 0.01 and 4.0% by weight;
V is between 0.01 and 2.0% by weight;
Zn is between 0.01 and 3.0% by weight;
Fe is between 0.01 and 2.5% by weight;
Cu is between 0.01 and 2.0% by weight;
Cr is between 0.01 and 4.0% by weight; and
Co is between 0.01 and 4.0% by weight.

18. The additive manufacturing alloy of claim 13, wherein an elongation of an as-printed alloy is at least 15%.

19. The additive manufacturing alloy of claim 13, wherein an elongation of an as-printed alloy is at least 17%.

20. The additive manufacturing alloy of claim 13, wherein an elongation of an as-printed alloy is at least 18%.

21. The additive manufacturing alloy of claim 13, wherein an ultimate tensile strength of an as-printed alloy is at least 400 megapascals.

22. The additive manufacturing alloy of claim 13, wherein an ultimate tensile strength of an as-printed alloy is at least 425 megapascals.

23. The additive manufacturing alloy of claim 13, wherein an ultimate tensile strength of an as-printed alloy is at least 440 megapascals.

24. The additive manufacturing alloy of claim 13, wherein an ultimate tensile strength of an as-printed alloy is at least 445 megapascals.

25. An additive manufacturing alloy comprising:
manganese (Mn) in a range from 0.7 to 2.9% by weight;
silicon (Si) in a range from 0.1 to 0.8% by weight; and
zirconium (Zr) in a range from 0.01 to 1.0% by weight; and
aluminum (Al).

26. The additive manufacturing alloy of claim 25, further comprising at least:
hafnium (Hf), lithium (Li), titanium (Ti), or yttrium (Y).

27. The additive manufacturing alloy of claim 26, wherein:
Hf is between 0.01 and 0.8% by weight;
Li is between 0.01 and 0.5% by weight;
Ti is between 0.01 and 2.0% by weight; and
Y is between 0.01 and 1.0% by weight.

28. The additive manufacturing alloy of claim 25, further comprising at least:
nickel (Ni), vanadium (V), zinc (Zn), iron (Fe), copper (Cu), chromium (Cr), or cobalt (Co).

29. The additive manufacturing alloy of claim 28, wherein:
Ni is between 0.01 and 4.0% by weight;
V is between 0.01 and 2.0% by weight;
Zn is between 0.01 and 3.0% by weight;
Fe is between 0.01 and 2.5% by weight;
Cu is between 0.01 and 2.0% by weight;
Cr is between 0.01 and 4.0% by weight; and
Co is between 0.01 and 4.0% by weight.

30. The additive manufacturing alloy of claim 25, wherein an elongation of an as-printed alloy is at least 15%.

31. The additive manufacturing alloy of claim 25, wherein an elongation of an as-printed alloy is at least 17%.

32. The additive manufacturing alloy of claim 25, wherein an elongation of an as-printed alloy is at least 18%.

33. The additive manufacturing alloy of claim 25, wherein an ultimate tensile strength of an as-printed alloy is at least 400 megapascals.

34. The additive manufacturing alloy of claim 25, wherein an ultimate tensile strength of an as-printed alloy is at least 425 megapascals.

35. The additive manufacturing alloy of claim 25, wherein an ultimate tensile strength of an as-printed alloy is at least 440 megapascals.

36. The additive manufacturing alloy of claim 25, wherein an ultimate tensile strength of an as-printed alloy is at least 445 megapascals.

37. An additive manufacturing alloy comprising:
manganese (Mn) in a range from 0.01 to 2.9% by weight;
silicon (Si) in a range from 0.01 to 3.9% by weight; and
zirconium (Zr) in a range from 0.01 to 2.8% by weight; and
aluminum (Al).
